(19) United States
(12) Patent Application Publication
(10) Pub. No.: US 2010/0131445 A1
(43) Pub. Date: May 27, 2010

(54) METHOD OF DATA TRANSMISSION WITH DIFFERENTIAL DATA FUSION

(75) Inventors: Chin-Hao Wu, Taipei County (TW); Yu-Chee Tseng, Hsinchu City (TW); Chi-Wen Teng, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INSTITUTE FOR INFORMATION INDUSTRY, Taipei (TW)

(21) Appl. No.: 12/336,532

(22) Filed: Dec. 17, 2008

(30) Foreign Application Priority Data
Nov. 26, 2008 (TW) 97145782

(51) Int. Cl. G06N 5/02; G06F 15/16

(52) U.S. Cl. 706/46; 709/223

(57) ABSTRACT

A data processing method for communication for a network having a plurality of nodes and a data collection device is provided. First, one of the nodes is selected according to a schedule for overhearing a reference data transmitted by a reference node to the data collection device. Then, a predicted data is calculated by the selected node according to the reference data and a corresponding prediction module. Next, the predicted data is compared with an actual data captured by the selected node, and an error between the predicted data and the actual data is transmitted to the data collection device. The selected node needs not to transmit any data to the data collection device if there is no error between the predicted data and the actual data. Thereby, the quantity of data to be transmitted is greatly reduced, and accordingly problems caused by insufficient bandwidth of the network are avoided.

### CROSS-REFERENCE TO RELATED APPLICATION

This application claims the priority benefit of Taiwan application serial no. 97145782, filed on Nov. 26, 2008. The entirety of the above-mentioned patent application is hereby incorporated by reference herein and made a part of specification.

### BACKGROUND OF THE INVENTION

1. Field of the Invention

The present invention generally relates to a data processing method, and more particularly, to a data processing method for communication wherein the quantity of data to be transmitted is reduced according to spatial correlation between the data.

2. Description of Related Art

In a wireless sensor network (WSN), sensor data is captured and transmitted back to a data collection device (for example, a computer system) by sensor nodes, so that the computer system can monitor an environment in real time according to the sensor data or restore the original scene in real time by using a computer graphic technique. Taking the WSN 100 illustrated in FIG. 1 as an example, after the sensor node A and the sensor node B respectively obtain a sensor data A and a sensor data B, the sensor node A and the sensor node B have to respectively transmit the sensor data A and the second data B back to the computer system 110. In other words, the bandwidth of the WSN 100 has to be able to cope with the quantity of data transmitted at the same time by all the sensor nodes.

However, regarding a system using a WSN, the requirements to high sampling rate, low transmission delay, and dense star network all make the bandwidth of the WSN the biggest bottleneck of the system. The requirement of high sampling rate is to capture fine actions or environmental information and accordingly to prevent distortion of sensor data and to achieve real-time imaging. For example, a sampling rate of about 100 Hz is used to capture body actions, while a sampling rate of about 8000 Hz is used to capture sounds. A high sampling rate usually means that data is produced in a rate higher than the bandwidth of the network. In a WSN, any environmental change may also cause the bandwidth to change drastically and accordingly packet loss or transmission delay may be caused.

The requirement of low transmission delay is to increase the smoothness for restoring data or rendering image. In a real-time scene restoration and display application, a sensor data has to be transmitted to a data collection device between adjacent two image frames in order to achieve a smooth and real image. In addition, in a real-time data recognition application, the data collection time has its upper limit, and data collected after this upper limit becomes meaningless. Whether foregoing requirements can be fulfilled is also limited by the bandwidth of the WSN.

The requirement of dense star network is to detect environmental variations within small regions so that many sensor nodes can be assembled within each other's transmission ranges to form a dense star network. In a star network, any two sensor nodes are directly connected. Thus, the problem of packet collision is caused and the average available bandwidth is also reduced.

In order to fulfill foregoing requirements with limited bandwidth, the existing method is to reduce the quantity of data to be transmitted through data compression. A single-node compression technique is to directly compress the data of each node before the data is transmitted. However, this method does not process the correlation between the data. A feature comparison compression technique is to extract features by using an established model and then compare the features and categorize the comparison result. Even though in this method, the quantity of data to be transmitted can be reduced through feature extraction, but comparison error may be produced and accordingly the original sensor data may not be restored. Even though some other methods, such as predicting the value of a current pixel by using the spatial correlation of adjacent pixels and storing a prediction or determining the quantity of data to be transmitted of a sensor node according to the priority of the sensor node, can also be used for resolving the problem of insufficient bandwidth, these methods can only process a single sensor node in a network, and the data collection device may not be able to obtain the original sensor data completely.

### SUMMARY OF THE INVENTION

Accordingly, the present invention is directed to a data processing method for communication, wherein data with spatial correlation is processed to reduce the quantity of data to be transmitted, so that the problems caused by insufficient network bandwidth can be avoided.

The present invention provides a data processing method for communication suitable for a network having a plurality of nodes and a data collection device. The data collection device collects data transmitted by the nodes. In the data processing method for communication, first, one of the nodes is selected according to a schedule to overhear a reference data transmitted by at least one reference node to the data collection device. Then, a predicted data is calculated by the selected node according to the reference data and a corresponding prediction module. After that, the predicted data is compared with an actual data captured by the selected node, and an error between the predicted data and the actual data is transmitted to the data collection device.

According to an embodiment of the present invention, the data processing method for communication further includes: obtaining a history data of each of the nodes and determining a spatial correlation between the history data when the nodes are in an offline state; and establishing the prediction module of each of the nodes according to the history data and the corresponding spatial correlation.

According to an embodiment of the present invention, the step of establishing the prediction module includes: obtaining the history data having the higher spatial correlation; and establishing the prediction module of the corresponding node according to the obtained history data.

According to an embodiment of the present invention, the step of establishing the prediction module includes processing the history data through a regression analysis method to establish the prediction module.

According to an embodiment of the present invention, after the step of establishing the prediction module of each of the nodes, the data processing method for communication further includes: obtaining a prediction standard error corresponding to each prediction module; and determining each node is used for calculating the predicted data of which nodes in the network and accordingly determining the schedule according to the prediction standard error, wherein the schedule includes the order in which the nodes transmit data to the data collection device.

According to an embodiment of the present invention, the step of determining the schedule further includes performing a clustering process to the prediction standard errors through a data clustering method to determine the schedule.

According to an embodiment of the present invention, the data processing method for communication further includes: respectively calculating a total of the corresponding prediction standard errors with each of the nodes used for calculating the other nodes; and defining the node having the lowest total as the first node for transmitting data in the schedule.

According to an embodiment of the present invention, the data processing method for communication further includes: establishing a directed graph by using each of the nodes and a prediction direction between the nodes; defining the prediction standard error as a cost of a corresponding edge in the directed graph with each of the nodes used for predicting the other nodes; obtaining a minimum spanning tree of the directed graph according to the cost of each edge; and defining the schedule according to the levels of the nodes in the minimum spanning tree.

According to an embodiment of the present invention, the data processing method for communication further includes calculating the corresponding prediction standard error with each of the unsorted nodes served as the last node for transmitting data among all the unsorted nodes; serving the node having the lowest prediction standard error as the last node for transmitting data among all the unsorted nodes; and executing foregoing steps repeatedly until all the nodes are sorted.

According to an embodiment of the present invention, after the step of determining the schedule, the data processing method for communication further includes transmitting the schedule and the prediction module of each of the nodes to the data collection device.

According to an embodiment of the present invention, the step of overhearing the reference data by the selected node includes overhearing the reference data through a wireless communication between the selected node and the reference nodes when each of the reference nodes broadcasts the reference data.

According to an embodiment of the present invention, after the step of overhearing the reference data by the selected node, the data processing method for communication further includes performing a decoding process to the reference data by the selected node.

According to an embodiment of the present invention, before transmitting the error to the data collection device by the selected node, the data processing method for communication further includes: performing an encoding process to the error; performing a corresponding decoding process to the error by the data collection device after the data collection device receives the error; and calculating the actual data of the selected node according to the prediction module corresponding to the selected node, the schedule, and the error.

According to an embodiment of the present invention, after the step of comparing the predicted data and the actual data, the data processing method for communication further includes not transmitting any data to the data collection device by the selected node when there is no error between the predicted data and the actual data; and calculating the actual data of the selected node by the data collection device according to the prediction module corresponding to the selected node and the schedule.

According to an embodiment of the present invention, the network includes a wireless network and a wired network. The wireless network comprises a wireless sensor network (WSN), a body sensor network (BSN), a wireless time division multiple access (TDMA) network and a wireless code division multiple access (CDMA) network. The wired network comprises a wired sensor network, a wired TDMA network and a wired CDMA network. And the data collection device may be a computer system, and each of the nodes includes an inertial sensor, a gyroscope, or a direction gauge.

In the present invention, prediction modules are established according to spatial correlation between data of nodes in a network. When a node in the network is about to transmit a data to a data collection device, first, a predicted data of the node is calculated by using the corresponding prediction module, and after comparing an actually captured data with the predicted data, only the error between the actual data and the predicted data is sent to the data collection device. Thereby, the quantity of data to be actually transmitted is greatly reduced, and accordingly problems caused by insufficient network bandwidth are avoided.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a conventional wireless sensor network (WSN).

FIG. 2 is a flowchart of a data processing method for communication according to an embodiment of the present invention.

FIG. 3 is a diagram of a data processing method for communication according to an embodiment of the present invention.

FIG. 4 is a diagram illustrating an order in which predicted data of a plurality of nodes is calculated according to an embodiment of the present invention.

FIG. 5 is a flowchart of a data processing method for communication according to another embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

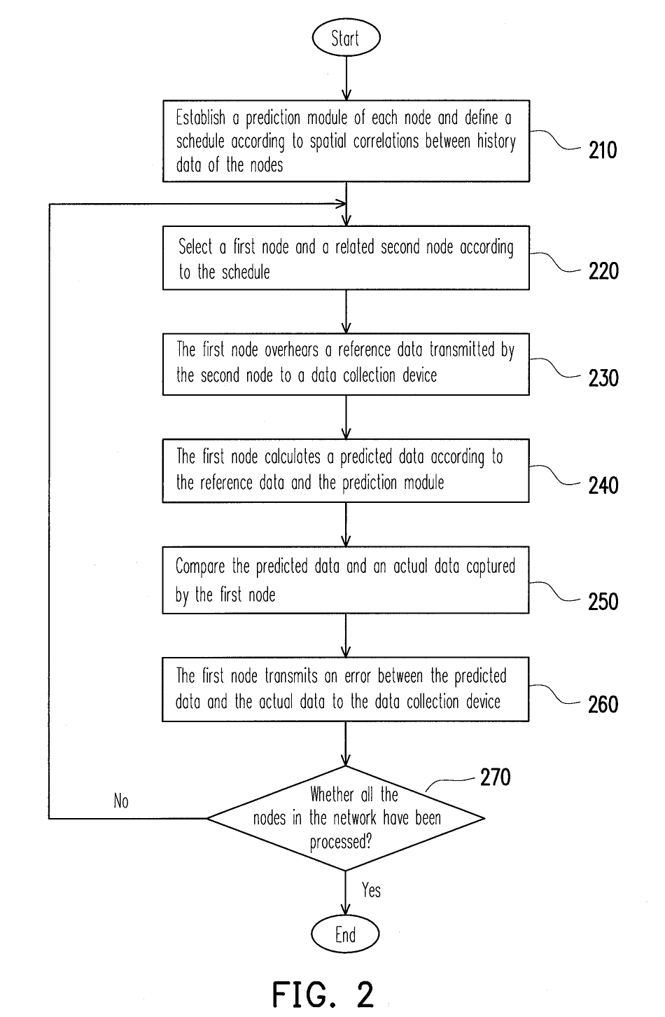

FIG. 2 is a flowchart of a data processing method for communication according to an embodiment of the present invention. Referring to FIG. 2, in the present embodiment, a network having a plurality of nodes and a data collection device is taken as an example to described how to reduce the quantity of data to be transmitted by using the spatial correlation between the data when each of the nodes is about to transmit data to the data collection device. The network may be a wireless network or a wired network, wherein the wireless network comprises a wireless sensor network (WSN), a body sensory network (BSN), a wireless time division multiple access (TDMA) network and a wireless code division multiple access (CDMA) network, and the wired network comprises a wired sensor network, a wired TDMA network and a wired CDMA network. It should be mentioned about that the present invention is not limited herein. However, for the convenience of illustration, the network is assumed to be the WSN in the following embodiments, and each of the nodes is disposed with a sensor device (for example, an inertial sensor, a gyroscope, or a direction gauge) for capturing different information, such as temperature, humidity, illumination, vibration, displacement, or flux, etc. The data collection device may be a computer system or any device with data processing capability, and the data collection device can process the data received from the nodes and present an integrated data.

First, in step 210, when the nodes in the network are in an offline state, a prediction module of each of the nodes is established according to the spatial correlation between history data of the nodes, and a specific schedule is defined. The schedule refers to an order in which the nodes in the network transmit data to the data collection device. In the present embodiment, the history data of the nodes may be previously captured data or any training data; however, the scope of the history data is not limited in the present invention. Below, how to establish the prediction module of each node and determining the schedule will be explained in detail.

After obtaining the history data of each node in the network, the spatial correlation between the history data is determined according to the distribution of the history data. For example, two history data with a similar data trend have higher spatial correlation. Next, the prediction module of each node is established according to all the history data and the corresponding spatial correlation. For example, to establish the prediction module of one of the nodes, first, a history data having higher (or the highest) spatial correlation with the history data of the current node is selected from the history data of the other nodes, and then the history data having the higher (or highest) spatial correlation is processed through a regression analysis method to establish the prediction module corresponding to the node. In an embodiment of the present invention, a model of the prediction module is pre-established by using a linear equation (or a non-linear equation), and the history data having the higher spatial correlation is then brought into the model to establish a complete prediction module. Assuming that the history data of a node A and a node B in the network has the highest spatial correlation, when establishing the prediction module of the node A, the history data of the node A and the node B is brought into the model of the prediction module and the prediction module is established by solving the equation. After the prediction module is established, data of the node A can be predicted according to the data of the node B and the prediction module.

A prediction module is used for predicting the data of a node by using the data of another node. However, the accuracy of predicting the data of the node B by using the data of the node A is different from the accuracy of predicting the data of the node A by using the data of the node B. Thus, in order to determine which node in the network should be used to predict another node to achieve a more accurate prediction, the accuracy of each prediction module has to be determined. Generally speaking, after a prediction standard error of a prediction module is calculated, the lower the prediction standard error is, the more accurate the prediction will be. Thus, in the present embodiment, the prediction standard error of each prediction module is obtained. Then, a clustering process is performed repeatedly to the prediction standard errors through a data clustering method, and a schedule is determined according to the optimal clustering result. Accordingly, each of the nodes is used for calculating the predicted data of which nodes in the network is determined, and the schedule of the nodes is also determined. For example, assuming the accuracy of predicting the data of the node B by using the node A is higher than the accuracy of predicting the data of the node A by using the node B, then in the schedule, the node A transmits data to the data collection device before the node B transmits data to the data collection device. As a result, the node B can obtain the data transmitted by the node A to calculate the predicted data of the node B.

It should be mentioned that two methods for determining the schedule regarding the situation that a node is used for predicting another node are provided in the present invention. In an embodiment of the present invention, first, a total of the corresponding prediction standard errors with each of the nodes used for predicting other nodes is respectively calculated. Then, the node having the lowest total is defined as the first node for transmitting data in the schedule. In other words, this node is used for predicting data of all the other nodes in the network.

In another embodiment of the present invention, first, a directed graph is established by using the nodes in the network and a prediction direction between the nodes, and the prediction standard error with each of the nodes used for predicting other nodes is defined as a cost on a corresponding edge in the directed graph. Next, a minimum spanning tree of the directed graph is obtained according to the cost of each edge. Finally, a schedule of all the nodes is defined according to the levels of the nodes in the minimum spanning tree. For example, the schedule of any node in the minimum spanning tree is always earlier than the schedule of its child nodes. In other words, each parent node in the minimum spanning tree is used for predicting the data of its child nodes.

The method used for determining the schedule of the nodes in a network is not limited in the present invention, and the schedule of the nodes can be determined through different method according to different network requirements. After establishing the prediction module of each node and defining the schedule, the prediction modules and the schedule are transmitted to the data collection device. Then, when the nodes are in an online state and accordingly can capture data, in step 220, one of the nodes in the network is selected according to the schedule (referred to as a first node thereinafter), and another reference node (referred to as a second node thereinafter) related to the first node is also obtained. The first node is the node which should be first processed among all the unprocessed nodes, and the second node is a node which should be referred to when the predicted data of the first node is calculated. In other words, the data of the first node and the second node has a high spatial correlation.

Because all the nodes in the network have direct wireless communication with each other, in step 230, when the second node broadcasts a reference data to the data collection device, the first node overhears the reference data through the wireless communication. In an embodiment of the present invention, after the first node overhears the reference data, the first node may perform a decoding process to the reference data to obtain the content thereof.

Thereafter, in step 240, the first node calculates a predicted data according to the reference data and the prediction module established in the offline state. In step 250, the first node captures an actual data and compares the actual data with the predicted data to obtain an error between the two. In step 260, the first node transmits the error between the actual data and the predicted data to the data collection device. In the present embodiment, the first node performs an encoding process to the error before transmitting the error to the data collection device so as to further reduce the quantity of data to be transmitted, wherein the encoding process may be Huffman coding or other compression techniques and which is not limited in the present invention. It should be mentioned that the first node transmits only the error between the actual data and the predicted data to the data collection device. In other words, if there is no error between the actual data and the predicted data, the first node needs not to transmit any data.

Finally, in step 270, whether all the nodes in the network have been processed is determined. If there is still node which is not determined whether to transmit data to the data collection device, the process returns to step 220 to select another unprocessed node according to the schedule and a reference node for predicting this unprocessed node. After that, the steps illustrated in FIG. 2 are executed repeatedly to predict the data of the unprocessed nodes by using those nodes which have transmitted data until all the nodes in the network are processed.

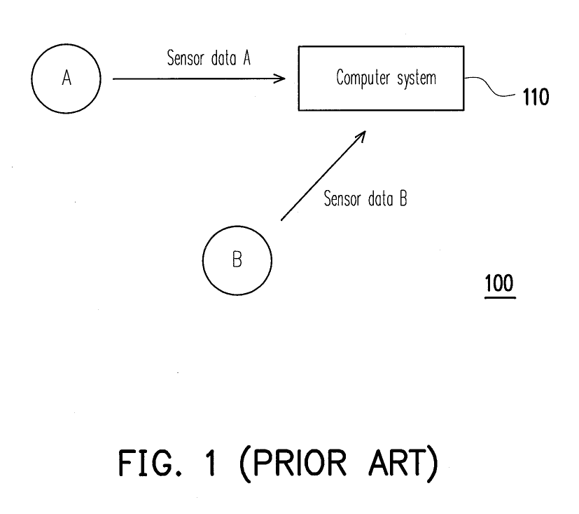

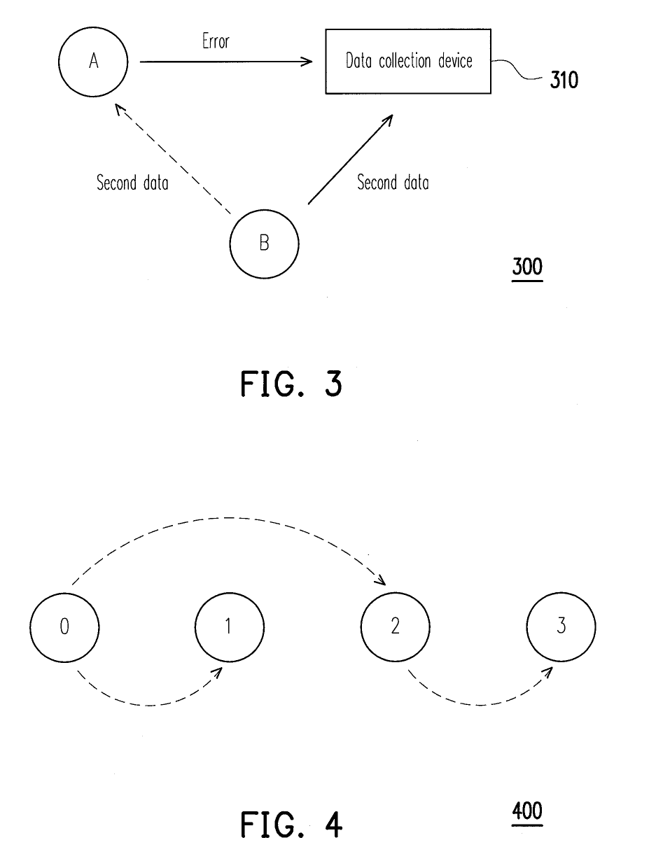

Next, the present invention will be described from the point of view of the data collection device. After the data collection device receives the error transmitted by the node, the data collection device performs a corresponding decoding process to the error to obtain the content thereof. Then, the data collection device calculates the data actually captured by the node which transmits the error according to the prediction module corresponding to the node, the schedule, and the error. Taking the network 300 in FIG. 3 as an example, assuming that the predicted data of the node A has to be calculated according to the data of the node B (referred to as a reference data thereinafter), after the node A overhears the reference data transmitted by the node B to the data collection device 310, the node A calculates its predicted data according to the prediction module thereof and the reference data. If there is an error between the predicted data and the actual data captured by the node A, the node A transmits the error to the data collection device 310. After the data collection device 310 receives the error transmitted by the node A, the data collection device 310 first determines that the data of the node A is predicted by using the node B in the network according to the schedule. Thus, the data collection device 310 calculates the actual data captured by the node A by using the reference data transmitted by the node B, the error transmitted by the node A, and the prediction module of the node A. However, if the node A determines that there is no error between the actual data captured by the node A and the predicted data, the node A does not transmit any data to the data collection device 310. In this case, the data collection device 310 determines that the data of the node A is predicted by using the node B according to the schedule and directly calculates the actual data of the node A by using the reference data previously transmitted by the node B and the prediction module of the node A. Meanwhile, it can be understood by comparing FIG. 1 and FIG. 3 that the node A in FIG. 3 does not need to transmit the actual data completely to the data collection device 310; instead, the node A needs only to transmit the error to the data collection device 310. Accordingly, the quantity of data to be transmitted in the network 300 is reduced, and the data compression rate is increased by using the spatial correlation between the data.

FIG. 4 is a diagram illustrating an order in which predicted data of a plurality of nodes is calculated according to an embodiment of the present invention. Referring to FIG. 4, the network 400 includes a node 0, a node 1, a node 2, and a node 3. As denoted by the arrows in FIG. 4, assuming that the node 0 is used for predicting the data of the node 1 and the node 2 and the node 2 is used for predicting the data of the node 3 according to the schedule, if the prediction module of each node in the network 400 is established accurately, only the node 0 needs to transmit the actually captured data completely to the data collection device (not shown) in the network 400. The data collection device can respectively calculate the data actually captured by the node 1, the node 2, and the node 3 according to the data transmitted by the node 0, the prediction module of each of the nodes, and the schedule. Compared to the conventional network transmission method, the quantity of data to be transmitted is reduced and accordingly the requirement to network bandwidth is greatly reduced. Moreover, since the data collection device can also obtain the data actually captured by the nodes, the real data can always be restored.

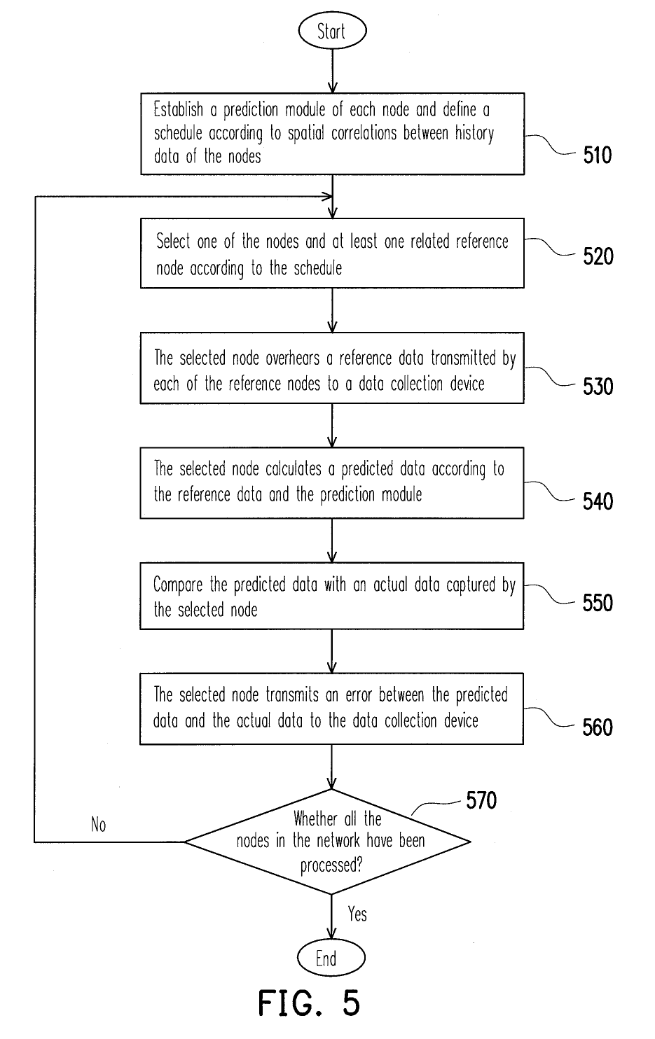

It should be stated that according to different network characteristic or performance requirement, the present invention further provides a method for predicting a node by using a plurality of nodes. FIG. 5 is a flowchart of a data processing method for communication according to another embodiment of the present invention. In the present embodiment, the number of reference nodes used for predicting a node is not limited.

Referring to FIG. 5, first, in step 510, when the nodes in the network are in an offline state, a prediction module of each node is established according to the spatial correlation between history data of the nodes, and a schedule of the nodes is defined. The method for establishing the prediction modules is similar to that described in foregoing embodiment (the history data having the higher spatial correlation is used for respectively establishing the prediction module of the corresponding node) therefore will not be described herein. In the present embodiment, the method for defining the schedule is to find out the node which is most suitable for transmitting data at the last among all the unsorted nodes and accordingly determine the order in which all the nodes transmit data. To be specific, in the present embodiment, a prediction standard error produced by using each of the nodes as the last node for transmitting data among the unsorted nodes is repeatedly calculated. Then, the node having the lowest prediction standard error is selected as the last node for transmitting data. For example, assuming the network has a node A, a node B, a node C, and a node D which are not sorted. While determining the schedule, the prediction standard error when each of foregoing four nodes is used as the last node for transmitting data is respectively calculated. Assuming the prediction standard error corresponding to node A is the lowest, then the node A is defined as the last node for transmitting data. After that, the last node for transmitting data is determined among the node B, the node C, and the node D, and the process goes on until the schedule of all the nodes is determined.

Through the method described above, a schedule suitable for predicting a node with one or more than one nodes is established. Thereafter, when the nodes in the network are in an online state, a node and at least one related reference node are selected from the network according to the schedule (step 520). When the reference nodes respectively transmit reference data to the data collection device, the selected node overhears the reference data (step 530). Next, the selected node calculates the predicted data thereof according to the reference data and the prediction module (step 540) and compares the predicted data with a captured actual data (step 550). When there is an error between the predicted data and the actual data, the selected node transmits the error to the data collection device (step 560). Finally, in step 570, whether all the nodes in the network have been processed is determined. If so, this data processing method for communication is terminated; otherwise, the process returns to step 520 to select the next node according to the schedule and at least one reference node for predicting the node. Steps 520˜570 are executed repeatedly to reduce the quantity of data to be transmitted.

It should be mentioned that the data processing method for communication provided by the present invention is especially suitable for a network wherein the data captured by each node presents a high spatial correlation. For example, when a WSN is applied to a body recovery application, a plurality of sensor nodes is deployed in the legs of the patient. When the patient executes a series of recovery actions, the sensor nodes capture data and transmit the data to a computer system so that the computer system can determine the correctness of the patient's actions. Because the data produced by the body actions present very high spatial correlation, data produced by the body actions is collected when the sensor nodes are in an offline state, and the spatial correlation between the data is calculated to establish the prediction modules of the sensor nodes and to determine the schedule. When the sensor nodes are in an online state, data of unprocessed nodes is predicted by using all the nodes which have transmitted data according to the schedule, and the errors are transmitted back to the computer system. Because the data of the sensor nodes present a very high spatial correlation, the accuracy of the predicted data is ensured, and the quantity of data to be transmitted is effectively reduced. Moreover, data delay or data loss caused by insufficient bandwidth are avoided.

As described above, in the data processing method for communication provided by the present invention, data of different nodes is processed according to the high spatial correlation between the data, and when a node is about to transmit data to a data collection device, the quantity of data to be transmitted is effectively reduced. Accordingly, the requirements of the high sampling rate, the low transmission delay, and the dense star network are ensured even with a limited network bandwidth.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A data processing method for communication, suitable for a network comprising a plurality of nodes and a data collection device, wherein the data collection device collects data transmitted by the nodes, the method comprising:
selecting one of the nodes according to a schedule to overhear a reference data respectively transmitted by at least one reference node to the data collection device;
calculating a predicted data according to the reference data and a prediction module corresponding to the selected node;
comparing the predicted data and an actual data captured by the selected node; and
transmitting an error between the predicted data and the actual data to the data collection device.

2. The data processing method for communication according to claim 1, further comprising:
obtaining a history data of each of the nodes when the nodes are in an offline state;
determining a spatial correlation between the history data; and
establishing the prediction module of each of the nodes according to the history data and the corresponding spatial correlation.

3. The data processing method for communication according to claim 2, wherein the step of establishing the prediction module of each of the nodes according to the history data and the corresponding spatial correlation comprises:
obtaining the history data having the higher spatial correlation; and
establishing the prediction module corresponding to the node according to the obtained history data.

4. The data processing method for communication according to claim 2, wherein the step of establishing the prediction module of each of the nodes according to the history data and the corresponding spatial correlation comprises:
establishing the prediction module through a regression analysis method.

5. The data processing method for communication according to claim 2, wherein after the step of establishing the prediction module of each of the nodes, the data processing method for communication further comprises:
obtaining a prediction standard error corresponding to each of the prediction modules; and
determining each of the nodes is used for calculating the predicted data of which nodes in the network and accordingly determining the schedule according to the prediction standard error.

6. The data processing method for communication according to claim 5, wherein the step of determining the schedule further comprises:
performing a clustering process to the prediction standard errors through a data clustering method to determine the schedule.

7. The data processing method for communication according to claim 5, further comprising:
respectively calculating a total of the corresponding prediction standard errors with each of the nodes used for predicting the other nodes; and
defining the node having the lowest total as the first node for transmitting data in the schedule.

8. The data processing method for communication according to claim 5, further comprising:
establishing a directed graph by using the nodes and a prediction direction between the nodes;
defining the prediction standard error with each of the nodes used for predicting the other nodes as a cost of a corresponding edge in the directed graph;
obtaining a minimum spanning tree of the directed graph according to the costs; and
defining the schedule according to levels of the nodes in the minimum spanning tree.

9. The data processing method for communication according to claim 5, further comprising:
calculating the corresponding prediction standard error with each of the unsorted nodes served as the last node for transmitting data among all the unsorted nodes;
serving the node having the lowest prediction standard error as the last node for transmitting data among all the unsorted nodes; and
executing foregoing steps repeatedly until all the nodes are sorted.

10. The data processing method for communication according to claim 5, wherein the schedule comprises an order in which the nodes transmit data to the data collection device.

11. The data processing method for communication according to claim 5, wherein after the step of determining the schedule, the data processing method for communication further comprises:
transmitting the schedule and the prediction module of each of the nodes to the data collection device.

12. The data processing method for communication according to claim 1, wherein the step of overhearing the reference data by the selected node comprises:
overhearing the reference data through a wireless communication between the selected node and the reference nodes when each of the reference nodes broadcasts the reference data.

13. The data processing method for communication according to claim 1, wherein after the step of overhearing the reference data by the selected node, the data processing method for communication further comprises:
performing a decoding process to the reference data by the selected node.

14. The data processing method for communication according to claim 1, wherein the step of transmitting the error to the data collection device further comprises:
performing an encoding process to the error by the selected node before transmitting the error.

15. The data processing method for communication according to claim 14, wherein after the step of performing the encoding process to the error and transmitting the error to the data collection device, the data processing method for communication further comprises:
performing a corresponding decoding process to the error by the data collection device; and
calculating the actual data of the selected node according to the prediction module corresponding to the selected node, the schedule, and the error.

16. The data processing method for communication according to claim 1, wherein after the step of comparing the predicted data and the actual data, the data processing method for communication further comprises:
not transmitting any data to the data collection device by the selected node if there is no error between the predicted data and the actual data; and
calculating the actual data of the selected node by the data collection device according to the prediction module corresponding to the selected node and the schedule.

17. The data processing method for communication according to claim 1, wherein the data collection device comprises a computer system.

18. The data processing method for communication according to claim 1, wherein each of the nodes comprises one of an inertial sensor, a gyroscope, and a direction gauge.

19. The data processing method for communication according to claim 1, wherein the network comprises a wireless network and a wired network.

20. The data processing method for communication according to claim 19, wherein the wireless network comprises a wireless sensor network (WSN), a body sensor network (BSN), a wireless time division multiple access (TDMA) network, and a wireless code division multiple access (CDMA) network.

21. The data processing method for communication according to claim 19, wherein the wired network comprises a wired sensor network, a wired TDMA network, and a wired CDMA network.
